(19) United States
(12) Patent Application Publication
(10) Pub. No.: US 2025/0033073 A1
(43) Pub. Date: Jan. 30, 2025

(54) Systems and Methods for Monitoring Paint Spray Booths

(71) Applicant: Global Finishing Solutions LLC, Osseo, WI (US)

(72) Inventors: Matthew Salvo, Eleva, WI (US); Brian Myers, Edmond, OK (US); William McFadden, Barrie (CA)

(21) Appl. No.: 18/441,096

(22) Filed: Feb. 14, 2024

Related U.S. Application Data
(60) Provisional application No. 63/528,837, filed on Jul. 25, 2023.

(51) Int. Cl. B05B 12/00; B05B 16/60

(52) U.S. Cl. CPC B05B 12/006; B05B 16/60

(57) ABSTRACT

Systems and methods for monitoring paint spray booths are utilized to monitor and catalog data related to filter life, booth temperature, electricity usage, gas usage, burner status, and/or other like paint spray booth parameters. A software application provides a user interface dashboard as well as various modes of connectivity for users to access the data collected thereby. The data, therefore, is accessible in real time in many various locations.

### CROSS-REFERENCE TO RELATED APPLICATIONS

The present invention claims priority to U.S. Prov. Pat. App. No. 63/528,837, titled “System and Method for Monitoring Paint Spray Booths,” filed Jul. 25, 2023, which is incorporated herein by reference in its entirety.

### TECHNICAL FIELD

The present invention relates to systems and methods for monitoring paint spray booths. Specifically, the systems and methods are utilized to monitor and catalog data related to filter life, booth temperature, electricity usage, gas usage, burner status, and/or other like paint spray booth parameters. A software application provides a user interface dashboard as well as various modes of connectivity for users to access the data collected thereby. The data, therefore, is accessible in real time in many various locations. Moreover, the data from several paint spray booths are accessible to a user or to user groups in real time in the various locations.

### BACKGROUND

A spray booth is generally a pressure-controlled closed environment that may be used to paint various objects. Typically, paint spray booths are used to paint vehicles. A paint spray booth's effective design promotes efficient paint application, minimizing contamination and maximizing the quality of the finished product. To ensure the ideal working conditions (such as, for example, temperature, airflow, humidity, and other like factors that may be important to the painting process), these environments are generally equipped with ventilation, consisting of mechanical fans and optionally burners to heat the air to speed paint drying. Toxic solvents and paint particles are typically exhausted outside after filtering and optionally treated to reduce air pollution. Prevention of fires and dust explosions is a high priority.

Filters that are used in paint spray booths are important to ensure that impurities are not introduced into a paint spray booth and further to ensure that volatile and toxic chemicals are not released into the atmosphere. Therefore, filters are typically provided upfront in an air ventilation and circulation system to filter air that is pulled in from the outside to circulate within the paint spray booth and on the backend of the air ventilation and circulation system to filter the air before it is released.

Monitoring filter life is therefore important to ensure that the air ventilation and circulation system adequately accomplishes the proper filtering of the air. Typically, filter monitoring in paint spray booths utilizes sensors that measure airflow velocity within the air ventilation and circulation system. However, monitoring the velocity of airflow can be inaccurate and unreliable as air speed can be affected by many factors besides filter quality. In addition, it is often difficult to employ air speed sensors within air circulation systems without disrupting the operation of the system. Therefore, air speed sensors are typically built into air ventilation and circulation systems when newly manufactured but are typically difficult to add to previously built and installed air ventilation and circulation systems. In addition, typical monitors for paint spray booths are often incompatible with other types and/or brands of paint spray booths beyond the ones for which they are manufactured.

A need, therefore, exists for improved systems and methods for monitoring paint spray booths. Specifically, a need exists for improved systems and methods for monitoring paint spray booths that is accurate, reliable, and unaffected by other parameters except for filter condition. More specifically, a need exists for improved systems and methods for monitoring paint spray booths that can be either manufactured into a new paint spray booth system or added to existing paint spray booths. Moreover, a need exists for improved systems and methods for monitoring paint spray booths that is compatible with many different types and/or brands of paint spray booths.

Further, typical monitoring systems for paint spray booths are limited in their connectivity, often being hardwired back to a basic user interface that is disposed on and/or specific to the paint spray booth that is monitored. To the extent that paint spray booths are connected to user interfaces in other ways, they are typically limited to one form of connectivity, such as, for example, cellular connectivity. Moreover, typical paint spray booth monitoring systems often do not provide alerts or other messaging of information to others.

A need, therefore, exists for improved systems and methods for monitoring paint spray booths that provides several ways to connect and present data to a user thereof. Moreover, a need exists for improved systems and methods for monitoring paint spray booths that allows users to access data and information concerning one or more paint spray booths in various locations removed from the physical location of the paint spray booths. More specifically, a need exists for improved systems and methods for monitoring paint spray booths that provides alerts or other messaging of information to others, especially users that are physically separate from the paint spray booths.

In addition, typical paint spray booth monitoring systems do not provide monitoring of several other key aspects of a paint spray booth besides filter life, such as booth temperature data, electricity usage, gas usage, burner status, and other like information. Moreover, typical paint spray booth monitoring systems do not provide tracking of changes to the paint spray booths, such as when filters are changed and/or cataloging of data that users can use to support regulatory requirements.

A need, therefore, exists for improved systems and methods for monitoring paint spray booths that measures and monitors other factors in a paint spray booth besides filter life, such as booth temperature, electricity usage, gas usage, burner status, and other like information. In addition, a need exists for improved systems and methods for monitoring paint spray booths that provide tracking of changes to the paint spray booths, such as the changing of filters. Moreover, a need exists for improved systems and methods for monitoring paint spray booths that allows for cataloging of data that users can use to support regulatory requirements.

Further, it is often difficult for a user or a user group to monitor multiple paint spray booths without physically visiting each paint spray booth and monitoring the same at the specific paint spray booths. In addition, physical access to paint spray booths may limit the ability of an organization to limit access to specific users or user groups or to specify levels of data access to the users or user groups as desired. A need, therefore, exists for improved systems and methods for monitoring a plurality of paint spray booths that is accessible by the user or user group at a single location. Moreover, a need exists for improved systems and methods for monitoring a plurality of paint spray booths that is accessible by the user or user group in a single portfolio at various locations. In addition, a need exists for improved systems and methods for monitoring a plurality of paint spray booths that provide various levels of data access to users or user groups as needed.

### SUMMARY OF THE INVENTION

The present invention relates to systems and methods for monitoring paint spray booths. Specifically, the systems and methods are utilized to monitor and catalog data related to filter life, booth temperature, electricity usage, gas usage, burner status, and/or other like paint spray booth parameters. A software application provides a user interface dashboard as well as various modes of connectivity for users to access the data collected thereby. The data, therefore, is accessible in real time in many various locations.

To this end, in an embodiment of the present invention, a system for monitoring parameters of a paint spray booth is provided. The system comprises: at least one differential pressure sensor associated with a paint spray booth; a processing unit for receiving data from the differential pressure sensor, and a display for displaying real-time differential pressure information of the paint spray booth. The system further comprises a communication protocol for sending the differential pressure information to a remote user.

It is, therefore, an advantage and objective of the present invention to provide improved systems and methods for monitoring paint spray booths.

Specifically, it is an advantage and objective of the present invention to provide improved systems and methods for monitoring paint spray booths that is accurate, reliable, and unaffected by other parameters except for filter condition.

More specifically, it is an advantage and objective of the present invention to provide improved systems and methods for monitoring paint spray booths that can be either manufactured into a new paint spray booth system or added to existing paint spray booths.

Moreover, it is an advantage and objective of the present invention to provide improved systems and methods for monitoring paint spray booths that is compatible with many different types and/or brands of paint spray booths.

In addition, it is an advantage and objective of the present invention to provide improved systems and methods for monitoring paint spray booths that provides several ways to connect and present data to a user thereof.

Moreover, it is an advantage and objective of the present invention to provide improved systems and methods for monitoring paint spray booths that allows users to access data and information concerning one or more paint spray booths in various locations removed from the physical location of the paint spray booths.

More specifically, it is an advantage and objective of the present invention to provide improved systems and methods for monitoring paint spray booths that provides alerts or other messaging of information to others, especially users that are physically separate from the paint spray booths.

Further, it is an advantage and objective of the present invention to provide improved systems and methods for monitoring paint spray booths that measures and monitors other factors in a paint spray booth besides filter life, such as booth temperature, electricity usage, gas usage, burner status, and other like information.

In addition, it is an advantage and objective of the present invention to provide improved systems and methods for monitoring paint spray booths that provide tracking of changes to the paint spray booths, such as the changing of filters.

Moreover, it is an advantage and objective of the present invention to provide improved systems and methods for monitoring paint spray booths that allows for cataloging of data that users can use to support regulatory requirements.

Further, it is an advantage and objective of the present invention to provide improved systems and methods for monitoring a plurality of paint spray booths that is accessible by the user or user group at a single location.

Still further, it is an advantage and objective of the present invention to provide improved systems and methods for monitoring a plurality of paint spray booths that is accessible by the user or user group in a single portfolio at various locations.

In addition, it is an advantage and objective of the present invention to provide improved systems and methods for monitoring a plurality of paint spray booths that provide various levels of data access to users or user groups as needed.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a display apparatus showing a graphic user interface for a user to interface with data and information measured and monitored by the present invention.

FIG. 2 illustrates an exemplary screenshot of a graphic user interface for the present invention.

FIG. 3 illustrates an exemplary chart showing exhaust/floor pressure over time providing a user with information relating to changing filters thereof in an embodiment of the present invention.

FIG. 4 illustrates an exemplary chart showing booth temperature over time in an embodiment of the present invention.

FIG. 5 illustrates exemplary screenshots showing booth performance in an embodiment of the present invention.

### DETAILED DESCRIPTION OF THE PRESENTLY PREFERRED EMBODIMENTS

The present invention relates to systems and methods for monitoring paint spray booths. Specifically, the systems and methods are utilized to monitor and catalog data related to filter life, booth temperature, electricity usage, gas usage, burner status, and/or other like paint spray booth parameters. A software application provides a user interface dashboard as well as various modes of connectivity for users to access the data collected thereby. The data, therefore, is accessible in real-time in many various locations.

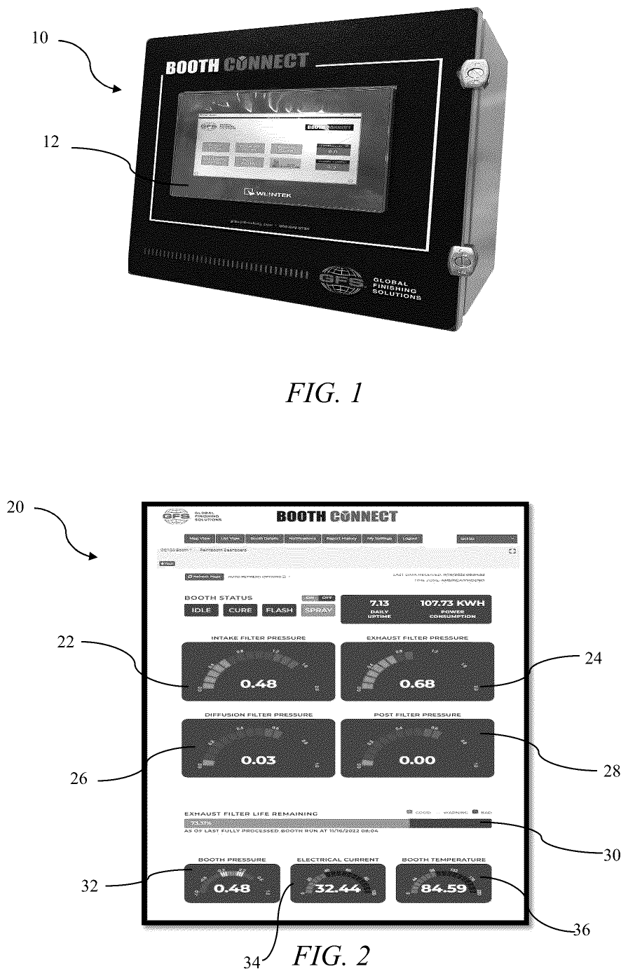

Referring to the figures, FIG. 1 illustrates an exemplary display and processing unit 10 in an embodiment of the present invention. The display and processing unit 10 is generally shown as a box having a display screen 12 thereon showing a graphic user interface (GUI) that may provide a user with access to data and information measured and monitored by the present invention. The box may have internal hardware for systems necessary to carry out the functions described herein. Moreover, the hardware may include a computer processor, memory, power means, and communication equipment for running the systems and methods described herein.

The present invention may utilize one or more sensors for measuring one or more parameters within a paint spray booth. In a preferred embodiment, the sensors may be differential pressure sensors that may be incorporated into an air ventilation and circulation system that is used to ventilate and circulate air through the paint spray booth. Therefore, the differential pressure sensors may provide information regarding the differential pressure of the paint spray booth at various points within the air ventilation and circulation system and, more specifically, within the paint spray booth itself. By measuring and monitoring the differential pressure at various locations within the air ventilation and circulation system of a paint spray booth, filter quality of the filters within the air ventilation and circulation system may be indirectly monitored. As a paint spray booth is used over time, filters may become clogged thereby diminishing the flow of air therethrough. Once the differential pressure measured by the one or more sensors reaches a particular capacity, the user may know or otherwise be alerted to change the filters.

A preferred sensor may be a differential pressure transmitter, which may monitor the differential pressure within the air ventilation and circulation system within the paint spray booth and wirelessly send differential pressure data to the display and processing unit 10, which may store and process the data received thereby. Of course, it should be noted that any differential pressure monitor may be utilized that may be incorporated into a paint spray booth. The display and processing unit 10 may display the data on the display screen 12, thereby providing real-time information concerning the differential pressure within the paint spray booth.

For example, as illustrated in FIG. 2, various differential pressure sensors may be utilized to compile data at various locations within the paint spray booth, such as, for example, at or near an intake filter, at or near an exhaust filter, at or near a diffusion filter, and/or at or near a post filter location. FIG. 2 illustrates a screenshot 20 of a GUI or dashboard showing exemplary real-time differential pressures at or near the intake filter 22, at or near the exhaust filter 24, at or near the diffusion filter 26, and at or near the post filter location 28. As further illustrated, the data received by the display and processing unit 10 relating to various differential pressures within the paint spray booth may be utilized to determine the “life remaining” of the exhaust filter, for example. Once the “life remaining” 30 icon reaches a critical pre-determined level, an alert may be communicated to a user to replace the filter.

Other information may be presented on the display screen 12, as shown by the screenshot illustrated in FIG. 2, which may relate to other parameters that may be measured or monitored by the present invention. For example, a plurality of gauge icons 32, 34, 36 may be presented that show the other parameters. For example, gauge icon 32 may display, generally, the real-time booth pressure of the paint spray booth. Gauge icon 34 may display the real-time electrical current of the electrical systems utilized in the paint spray booth, which may be measured, in a preferred embodiment, by an active current transducer. Of course, it should be noted that any current monitoring sensor may be utilized as apparent to one of ordinary skill in the art and the present invention. Gauge icon 36 may display the booth temperature of the paint spray booth. Of course, it should be noted that any information may be displayed on the display screen 12 that may be measured or monitored by the present invention.

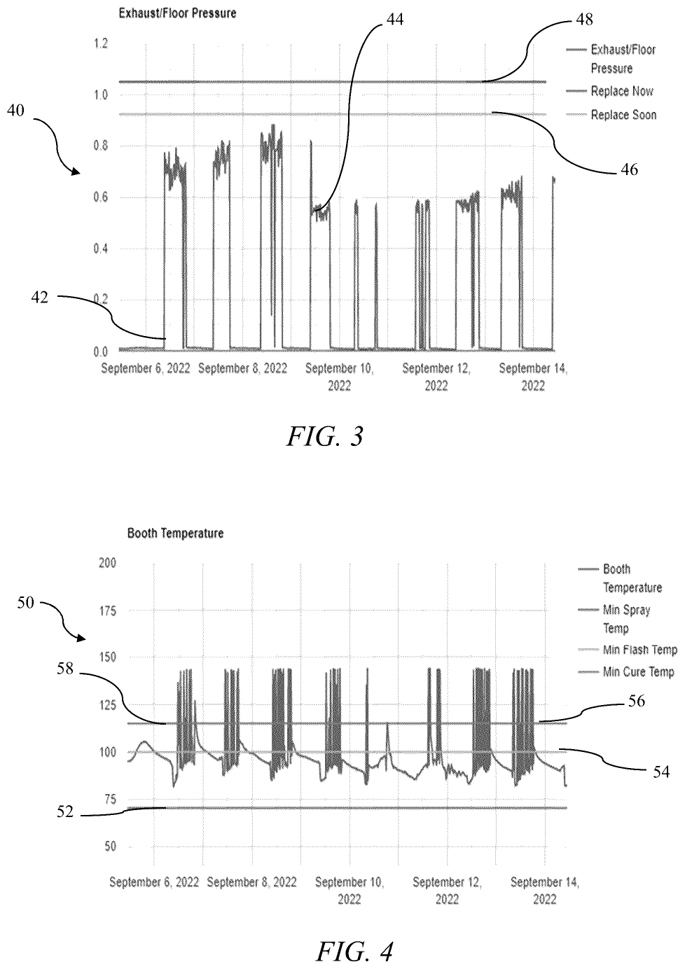

FIG. 3 illustrates an exemplary chart 40 that may be shown to a user of the present invention showing exemplary differential pressure monitoring information measured by the present invention and graphed over time. As illustrated, line 42 illustrates exemplary exhaust/floor differential pressure measurements at certain time intervals, for example, from Sep. 6, 2022, to Sep. 14, 2022. In use over time, the differential pressure illustrated by the line 42 may increase until the filters are replaced, at which time the differential pressure may drop, as illustrated at point 44. In addition, the chart 40 may have alert lines that show to a user a suggested time for replacing the filters within the paint spray booth. Specifically, alert line 46 may alert a user that the filters should be replaced soon whereas alert line 48 may alert a user that the filters should be replaced now or in the near future.

FIG. 4 illustrates other parameters that may be measured as well as other exemplary alerts lines that may be presented. Specifically, FIG. 4 illustrates a chart 50 showing paint spray booth temperature measurements over time, specifically from Sep. 6, 2022, to Sep. 14, 2022. Visually, the booth temperatures may be shown via line 52. A user may visually relate the booth temperatures via line 52 with various minimum booth temperatures one may want to know for different purposes within the paint spray booth. For example, a minimum spray temperature line 54 may be presented, a minimum flash temperature line 56 may be presented, and a minimum cure temperature line 58 may be presented on the chart 50. These temperature lines may provide visual information to a user relating actual real-time temperatures, as measured by paint spray booth temperature sensors, to temperatures desired for specific purposes, such as spray, flash, and/or cure.

Another parameter that may be measured and/or approximated within a paint spray booth is gas consumption, specifically gas consumed during a paint/cure cycle, without the use of or need to install a gas flow meter, which may be difficult to and add expense thereto. Specifically, using existing sensors, the gas consumed during paint/cure cycles may be determined. More specifically, air flow rate and temperature rise may be recorded at set intervals during one or more paint/cure cycles to determine an air heater firing rate in Btu/hr. At each interval, the air heater firing rate may be used to determine the gas consumed during the interval. The sum of gas consumed at each interval would provide an approximation of the total gas consumed during the paint/cure cycle.

In a preferred embodiment, the air heater firing rate may be calculated at a particular time interval using Equation 1, below:

$$Firing rate ( Btu / hr ) = ( Air flow rate ( cfm ) \times Temperature Rise ( ° F ) \times 1.08 ) / 0.92 \qquad ( Eq . 1 )$$

The gas consumed at each time interval may then be calculated using Equation 2, below:

$$Gas consumed ( {ft}^{3} ) = Firing rate ( Btu / hr ) / Time interval ( hr ) / Fuel heating value ( Btu / {ft}^{3} ) \qquad ( Eq . 2 )$$

The “Fuel heating value” is a constant based on the type of fuel in the paint/cure cycle. Specifically, natural gas has a fuel heating value of approximately 1000 Btu/hr whereas propane has a fuel heating value of approximately 2500 Btu/hr. Once the “Gas consumed” for the time interval is calculated, as specified above via Equations 1 and 2, a total gas consumed for the paint/cure cycle may be calculated using Equation 3, below:

$$Total gas consumed = gas consumed ( interval 1 ) + gas consumed ( interval 2 ) , etc . \qquad ( Eq . 3 )$$

The various sensors within the paint spray booth may be either wired or wireless and may communicate with the display and processing unit 10 to send the data collected thereby. As noted above, the display and processing unit 10 may compile and process the data and display the same to users, such as on the display screen 12. Alternatively, the information compiled and processed by the display and processing unit 10 may send the information wirelessly to users that are remote from the paint spray booth. For example, the data and information may be connected and presented to others via the Internet such as via ethernet, wireless internet, cellular modem connections, or any other communication protocol apparent to one of ordinary skill in the art. Therefore, the data may be presented to users remotely by displaying the same on remote screens, such as display screens on personal computers, laptop computers, tablet computers, smart phones, and other like displays. Of course, users and/or user groups may have specified access levels to information that may be compiled and presented using the systems and methods of the present invention, for security purposes and for any other purpose.

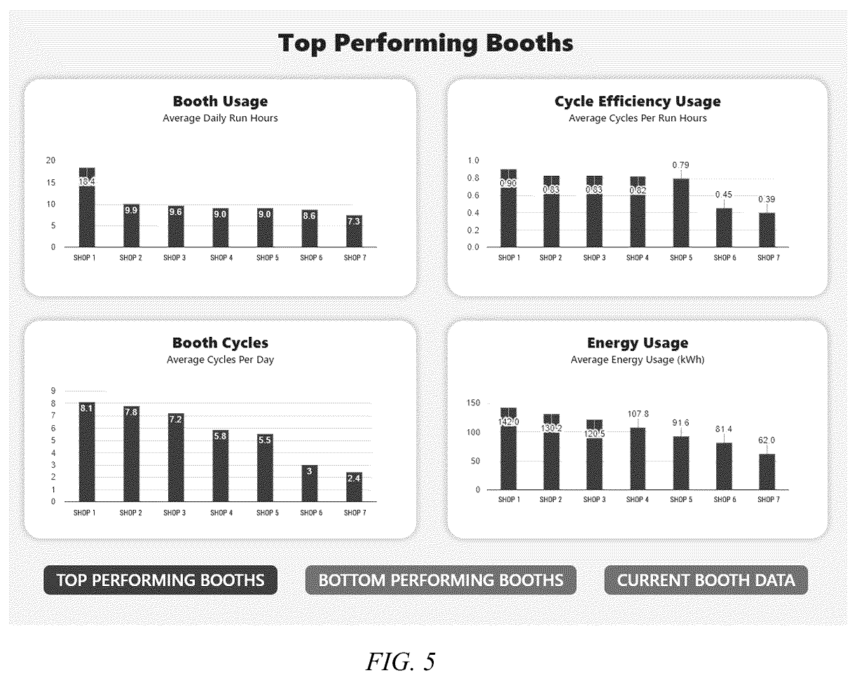

Specifically, the display may show the dashboard of the present invention in any manner desired by a user thereof to display the information important to the user. A user may access and view this data both at the site of the paint spray booth and/or remotely. Therefore, users may obtain real-time and historical data relating to how one or more paint spray booths may be performing. In addition, multiple paint spray booths may be monitored by a user or a user group at a single location, such as remotely or at a specific work station. The data compiled by the various sensors for each paint spray booth at different locations may be compared and/or shown or presented to the user and/or the user group having access to the data. As illustrated in FIG. 5, various sensor data is illustrated in various screenshots, showing how different paint spray booths, such as paint spray booths in different locations, compare. For example, FIG. 5 illustrates a screenshot showing “Top Performing Booths” in an organization, specifically showing “Booth Usage” (average daily run hours), “Cycle Efficiency Usage” (average cycles per run hours), “Booth Cycles” (average cycles per day), and “Energy Usage” (average energy usage (kWh). Thus, various data measured and/or calculated using sensor measurements, as described herein, may be presented and compared together. Moreover, while FIG. 5 illustrates “Top Performing Booths” within an organization, a user may further select “Bottom Performing Booths” showing booths performing relatively poorly when compared to other booths. Of course, the data may be presented to a user or a user group in any manner and the present invention should not be limited as described herein.

As noted above, alerts may be communicated to users, such as users that may be physically present at the site of the paint spray booth. However, because the display and processing unit 10 may be in communication with remote users, alerts may also be sent to remote users as well. For example, if a paint spray booth requires a change of filters based on differential pressure monitoring of the air ventilation and circulation system, an alert may be generated and sent to users both on side and remote. The alerts may be in the form of emails, instant messages, texts, or other like communications.

As further noted, historical data of the sensors may also be stored and recalled later for various purposes. For example, when filters are changed may be required to be communicated to regulatory agencies. The present invention allows for the tracking and storage of this historical data.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

What is claimed is:

1. A system for monitoring parameters of a paint spray booth comprising:
a first differential pressure sensor associated with a paint spray booth, wherein the paint spray booth comprises at least one air filter;
a processing unit for receiving data from the first differential pressure sensor; and
a display for displaying real-time differential pressure information of the paint spray booth from the first differential pressure sensor.

2. The system of claim 1 further comprising:
a communication protocol for sending the differential pressure information to a remote user.

3. The system of claim 1 wherein the at least one differential pressure sensor is mounted within an air ventilation and circulation system.

4. The system of claim 1 wherein the first pressure differential sensor comprises a transmitter and further wherein the processing unit comprises a receiver, wherein the transmitter is configured to send differential pressure sensor data of the paint spray booth to the receiver.

5. The system of claim 1 wherein the display shows real-time or near real-time differential pressure sensor data of the paint spray booth.

6. The system of claim 1 wherein the display illustrates a threshold and further wherein the display illustrates whether the differential pressure sensor data from the first differential pressure sensor reaches the threshold.

7. The system of claim 1 further comprising:
a second differential pressure sensor associated with the paint spray booth, wherein the first differential pressure sensor is located in a first location within an air ventilation and circulation system and further wherein the second differential pressure sensor is located in a second location within the air ventilation and circulation system.

8. The system of claim 1 further comprising:
an electrical current sensor associated with the paint spray booth configured to measure an electrical current within the paint spray booth; and
an electrical current gauge icon on the display configured to show a measurement of the electrical current of the paint spray booth measured by the electrical current sensor.

9. The system of claim 8 wherein the electrical current sensor is a current transducer.

10. The system of claim 1 further comprising:
a temperature sensor associated with the paint spray booth configured to measure a temperature within the paint spray booth; and
a temperature gauge icon on the display configured to show a measurement of the temperature within the paint spray booth measured by the temperature sensor.

11. The system of claim 1 further comprising:
a transmitter associated with the processing unit for wirelessly sending the data from the processing unit to a remote receiver.

12. A method for monitoring parameters of a paint spray booth comprising:
providing a paint spray booth;
associating a first differential pressure sensor with the paint spray booth, wherein the paint spray booth comprises at least one air filter;
providing a processing unit for receiving data from the first differential pressure sensor;
sending the data from the first differential pressure sensor to the processing unit;
providing a display associated with the processing unit; and
displaying real-time differential pressure information of the paint spray booth from the first differential pressure sensor.

13. The method of claim 12 further comprising the step of:
sending an alert to the display, wherein the alert indicates that the at least one air filter should be changed.

14. The method of claim 12 further comprising the steps of:
providing a communication protocol for sending the differential pressure information to a remote user; and
sending the differential pressure information to the remote user.

15. The method of claim 12 wherein the at least one differential pressure sensor is mounted within an air ventilation and circulation system within the paint spray booth.

16. The method of claim 12 wherein the first pressure differential sensor comprises a transmitter and further wherein the processing unit comprises a receiver; further comprising the step of:
sending the differential pressure sensor information of the paint spray booth to the receiver.

17. The method of claim 12 further comprising the step of:
displaying real-time or near real-time differential pressure sensor information of the paint spray booth.

18. The method of claim 12 further comprising the steps of:
illustrating a pressure threshold on the display wherein the display further illustrates whether the differential pressure sensor information from the first differential pressure sensor reaches the threshold.

19. A method of monitoring a parameter within a paint spray booth comprising the steps of:
providing a paint spray booth;
associating an air flow rate sensor and a temperature rise sensor with the paint spray booth;
measuring an air flow rate with the air flow rate sensor and a temperature rise with the temperature rise sensor during a first time interval of a paint/cure cycle within the paint spray booth;
calculating a firing rate for the first time interval using the air flow rate and the temperature rise; and
calculating a “gas consumed” amount of gas used for the paint/cure cycle for the first time interval using the firing rate and the fuel heating value constant of the gas.

20. The method of claim 19 further comprising the step of:
determining a total gas consumed value for the paint/cure cycle by measuring multiple gas consumed amounts curing multiple time intervals during the paint/cure cycle.
